(19) United States
(12) Patent Application Publication
(10) Pub. No.: US 2024/0160888 A1
(43) Pub. Date: May 16, 2024

(54) REALISTIC, CONTROLLABLE AGENT SIMULATION USING GUIDED TRAJECTORIES AND DIFFUSION MODELS

(71) Applicant: NVIDIA Corporation, Santa Clara, CA (US)

(72) Inventors: Davis Winston Rempe, Redwood, CA (US); Karsten Julian Kreis, Vancouver (CA); Sanja Fidler, Toronto (CA); Or Litany, Sunnyvale, CA (US); Jonah Philion, Toronto (CA)

(73) Assignee: NVIDIA Corporation, Santa Clara, CA (US)

(21) Appl. No.: 18/193,982

(22) Filed: Mar. 31, 2023

Related U.S. Application Data
(60) Provisional application No. 63/424,593, filed on Nov. 11, 2022.

(51) Int. Cl. G06N 3/02

(52) U.S. Cl. CPC G06N 3/02

(57) ABSTRACT

In various examples, systems and methods are disclosed relating to neural networks for realistic and controllable agent simulation using guided trajectories. The neural networks can be configured using training data including trajectories and other state data associated with subjects or agents and remote or neighboring subjects or agents, as well as context data representative of an environment in which the subjects are present. The trajectories can be determining using the neural networks and using various forms of guidance for controllability, such as for waypoint navigation, obstacle avoidance, and group movement.

### CROSS-REFERENCE TO RELATED APPLICATIONS

The present application claims the benefit of and priority to U.S. Provisional Application No. 63/424,593, filed Nov. 11, 2022, the disclosure of which is incorporated herein by reference in its entirety.

### BACKGROUND

Machine learning models, such as neural networks, can be used to simulate movement of agents in environments, such as for pedestrian movements in simulated environments. However, various models may lack realism with respect to movements, or may lack the ability to determine movements in a manner that can respond to user inputs.

### SUMMARY

Embodiments of the present disclosure relate to systems and methods for generating trajectories of subjects or agents, such as pedestrians. For example, diffusion (denoising) networks can be configured to determine trajectories according to past trajectories of subjects, trajectories of remote subjects, and local grid context information together with guidance indicative of objectives or criteria of the movement of the subjects. As compared with conventional systems, such as those described above, systems and methods in accordance with the present disclosure can allow for more realistic, controllable trajectory generation, such as by using training data examples to configure (e.g., update or train) the neural networks and configuring the neural networks with the guidance objectives and criteria.

At least one aspect relates to a processor. The processor can include one or more circuits to identify one or more criteria for movement of a subject in an environment. The one or more circuits can determine, using a neural network, a trajectory of the subject according to the one or more criteria. The neural network can be configured using training data representing subject trajectories. The one or more circuits can update a representation of the trajectory of the subject in the environment. The one or more circuits can present, using a display, the trajectory of the subject in the environment.

In some implementations, the subject is a first subject. The one or more circuits can determine, using the neural network, the trajectory further according to a position of the subject, motion of one or more second subjects, and a map representing features of the environment. The one or more criteria can correspond to at least one of collision avoidance or distance to maintain with respect to one or more second subjects.

In some implementations, the neural network includes a diffusion model configured to determine the trajectory by denoising a representation of one or more candidate trajectories based at least on the one or more criteria. The diffusion model can perform the denoising between a first time point and a second time point to determine the trajectory at the second time point, can determine the representation of the one or more candidate trajectories at the second time point, and can modify the representation using the one or more criteria at the second time point.

In some implementations, the training data includes a first subset of training data having a first type of annotation and a second set of training data having a second type of annotation. The trajectory can include a plurality of locations, and the one or more circuits can determine, using the neural network, the trajectory further by identifying one or more features of the environment at the plurality of locations. The one or more circuits can operate a controller of an autonomous vehicle in the environment, according to the trajectory of the subject.

At least one aspect relates to a processor. The processor can include one or more circuits to determine, using a neural network and based at least on processing a training data instance including a trajectory of a subject, an estimated trajectory of the subject. The one or more circuits can update one or more parameters of the neural network according to the trajectory and the estimated trajectory.

In some implementations, the neural network can apply noise to the trajectory to determine a noisy trajectory and modify the noisy trajectory to determine the estimated trajectory. The one or more circuits can update the one or more parameters of the neural network responsive to a comparison of the trajectory and the estimated trajectory. In some implementations, the one or more circuits can configure the neural network using a plurality of training data instances comprising the training data instance, the plurality of training data instances including a first subset having a first type of annotation and a second subset having a second type of annotation different from the first type.

At least one aspect relates to a method. The method can include identifying, by using one or more processors, one or more criteria for movement of a subject in an environment. The method can include determining, by the one or more processors and using a neural network, a trajectory of the subject according to the one or more criteria, the neural network configured using training data representing subject trajectories. The method can include updating, using the one or more processors, a representation of the trajectory of the subject in the environment. The method can include presenting, using the one or more processors and using a display, the trajectory of the subject in the environment.

In some implementations, the subject is a first subject. The method can include determining, using the neural network, the trajectory further according to a position of the subject, motion of one or more second subjects, and a map representing features of the environment. The one or more criteria can correspond to at least one of collision avoidance or distance to maintain with respect to one or more second subjects.

In some implementations, the neural network includes a diffusion model configured to determine the trajectory by denoising a representation of one or more candidate trajectories based at least on the one or more criteria. The diffusion model can perform the denoising between a first time point and a second time point to determine the trajectory at the second time point, can determine the representation of the one or more candidate trajectories at the second time point, and can modify the representation using the one or more criteria at the second time point.

In some implementations, the training data includes a first subset of training data having a first type of annotation and a second set of training data having a second type of annotation. The trajectory can include a plurality of locations, and the method can include determining, using the neural network, the trajectory further by identifying one or more features of the environment at the plurality of locations. The method can include operating a controller of an autonomous vehicle in the environment, according to the trajectory of the subject.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for performing generative AI operations using a large language model (LLM), a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for controllable trajectory generation using neural network models are described in detail below with reference to the attached drawing figures, wherein:

FIG. 1 is a block diagram of an example system for configuring a diffusion model for performing controllable trajectory generation, in accordance with some embodiments of the present disclosure;

FIG. 2 is a block diagram of an example system for controllable trajectory generation, in accordance with some embodiments of the present disclosure;

FIG. 3 is a flow diagram of an example of a method for controllable trajectory generation using neural network models, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to systems and methods for generating trajectories of subjects or agents, such as pedestrians, in simulation environments. The trajectories can be controllable to allow for criteria regarding the trajectories to be defined and implemented, such as for the subjects to move through waypoints, avoid collisions, or move in groups. This can allow for more realistic simulations, which can be useful for visual/simulation computing applications including crowd simulation, animation, building design, video games, and synthetic data generation, such as for simulating operation of autonomous vehicles.

Some systems can use analytical and/or rules-based approaches for simulating trajectories, such as to apply rules for criteria such as collision avoidance, social distance, and parameters such as velocity or acceleration bounds. However, these approaches can result in unrealistic movements, such as movements that may not appear human-like for simulating pedestrians. Some systems can use neural network-based models that can be trained on data of human movement, but these systems may lack the ability to be controlled, such as to react to newly introduced or unfamiliar obstacles, or to implement criteria for the trajectories at test time (e.g., runtime, inference time, during a simulation or as part of setup of the simulation).

Systems and methods in accordance with the present disclosure can use machine learning-based simulation models that can generate realistic trajectories, and can incorporate guidance for controlling the simulation at test time. The trajectories can be for any of a variety of agents, including but not limited to simulated agents for human/pedestrian or vehicle, such as autonomous vehicle, agent trajectories. The trajectories can be for various agents that may move in relatively smooth manners which may be represented, for example, using two-dimensional bounding boxes.

For example, the system can use generative models or other models that can sample from a distribution of potential trajectories based at least on the guidance (e.g., diffusion models), and that are trained using training data of human (or other specific types of subjects) movements and trajectories. The system can train and/or update training using (for example and without limitation) classifier-free approaches to enable the models to be responsive to guidance at test time. The classifier-free training can facilitate the use of various forms of datasets and/or annotations. In the example of a diffusion model-based approach, the system can use a function (e.g., objective function) representing the guidance as part of the denoising process by which the diffusion model determines trajectories, which can allow the guidance to perturb the trajectories towards satisfying the criteria.

The system can use a semantic map to facilitate determining the trajectory. For example, a spatial grid can have cells labeled with semantic information, such as classes, categories, and/or characteristics of objects present in the cells, which the model can be trained to take into account as part of determining the trajectories. The system can determine the trajectories using information regarding positions and movement of other subjects in the environment.

The systems and methods described herein may be used for a variety of purposes, by way of example and without limitation, for synthetic data generation, machine control, machine locomotion, machine driving, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI with large language models, light transport simulation (e.g., ray-tracing, path tracing, etc.), collaborative content creation for 3D assets, cloud computing and/or any other suitable applications.

Disclosed embodiments may be comprised in a variety of different systems such as systems for performing synthetic data generation operations, automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems implemented at least partially in a data center, systems for performing conversational AI operations, systems implemented with one or more LLMs, systems for performing light transport simulation, systems for performing collaborative content creation for 3D assets, systems implemented at least partially using cloud computing resources, and/or other types of systems.

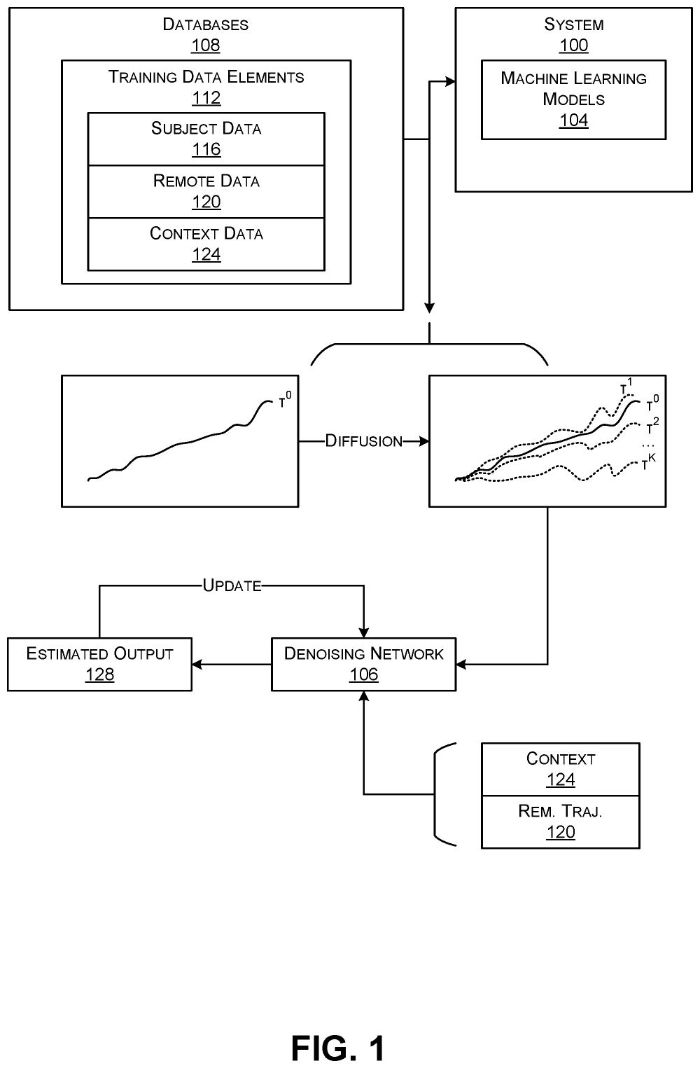

FIG. 1 is an example computing environment including a system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., machine learning model), operation, routine, logic, or instructions to perform functions such as configuring machine learning models 104 as described herein, such as to configure machine learning models to operate as diffusion models and/or trajectory generation models.

The system 100 can train, update, or configure one or more models 104. The models 104 can include machine learning models or other models that can generate target outputs based on various types of inputs. The models 104 may include one or more neural networks. The neural network can include an input layer, an output layer, and/or one or more intermediate layers, such as hidden layers, which can each have respective nodes. The system 100 can train/update the neural network by modifying or updating one or more parameters, such as weights and/or biases, of various nodes of the neural network responsive to evaluating estimated outputs of the neural network.

The models 104 can be or include various neural network models, including models that are effective for operating on or generating data including but not limited to image data, video data, text data, speech data, audio data, or various combinations thereof. The models 104 can include one or more transformers, recurrent neural networks (RNNs), long short-term memory (LSTM) models, other network types, or various combinations thereof. The models 104 can include generative models, such as generative adversarial networks (GANs), Markov decision processes, variational autoencoders (VAEs), Bayesian networks, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof.

The models 104 can include at least one trajectory model 104. The trajectory model 104 can include any function, model (e.g., neural network or other machine learning model), operation, routine, logic, or instructions to perform functions such as determining trajectories of subjects according to various parameters. For example, the trajectory model 104 can determine a trajectory of a subject in an environment according to one or more of a past trajectory of the subject, a past trajectory of one or more remote subjects, or context information regarding the environment. The context information can include or be determined according to various rules, policies, or heuristics with respect to realistic movement and trajectories, and may be processed by the trajectory model 104 in a manner that allows for controllability of the determination of the trajectory of the subject.

In some implementations, the trajectory model 104 includes at least one generative model or neural network, such as at least one diffusion model. The diffusion model can be a continuous time diffusion model. The diffusion model can include a neural network, such as a denoising network (e.g., denoising network 106 as described further herein). For example, in brief overview, the diffusion model can include a network that is trained, updated, and/or configured using training data that includes data elements to which noise is applied, and configuring the network to modify the noisy data elements to recover the (un-noisy) data elements.

The system 100 can configure the trajectory model 104 to determine, for a subject, at a given time step t, a state trajectory indicating at least one future state of the subject. The future state of the subject can be a state of the subject at a time step subsequent to t. The trajectory model 104 can determine a plurality of future states of the subject τ_{S}=[Sₜ₊₁, Sₜ₊₂, . . . S_{t+Tf}], where T_{f} represents a number of time steps, and the state s can be defined as a vector or matrix of position and/or motion data of the subject, such as [x, y, θ, v]^{T}, where x and y represent position of the subject in two dimensions (e.g., horizontal/vertical directions in a 2D plan view of the environment), θ represents a heading angle (e.g., angle of direction) of the subject, and v represents a speed of the subject. The states s can include, among various parameters, the heading as a two-dimensional heading vector (e.g., in the dimensions of x and y), a bounding box of the subject (e.g., length and width dimensions of the bounding box), an indication of whether the person is visible or occluded, or various combinations thereof.

In some implementations, the system 100 determines the state Ts according to at least one action τₐ=[aₜ₊₁, aₜ₊₂, . . . a_{t+Tf}]. Each action at can be defined as a vector or matrix representative of motion data, such as aₜ=[\dot{v}, \dot{θ}]^{T}, where \dot{v} represents acceleration and \dot{θ} represents rate of change of heading (e.g., yaw rate). For example, the state τ_{S} can be determined according to a function f(Sₜ, τₐ), such as a dynamics model to allow the system 100 to determine the state trajectory τ_{S} based at least on an initial (or current) state Sₜ and the plurality of actions τₐ. For example, the dynamics model can be a unicycle model or other model or function that can determine movement or other state information from action information. As such, the system 100 can define a full state-action trajectory as [τ_{S}, τₐ].

In some implementations, the system 100 can configure the trajectory model 104 to determine the future trajectory of the subject (e.g., determine at least one of τ_{S} and τₐ) based at least on (i) one or more past states (e.g., a past state trajectory of the subject): x^{ego}=[S_{t-Tp}, S_{t-Tp+1} . . . Sₜ], (ii) one or more past states (e.g., past state trajectories) of one or more remote subjects: X^{neigh}={xⁱ}ᵢ₌₁^{N}; or (iii) a map context in a frame (e.g., frame of reference; local frame) of the subject: [symbol] ∈ [symbol] ^{H×W×C}. C can be defined as a conditioning context that includes x^{ego} and/or X^{neigh}, e.g. C={x^{ego}, X^{neigh}, [symbol] }. In some implementations, the map context [symbol] includes a plurality of pixels arranged around the subject, such as by being cropped from a full context to a plurality of pixels extending outward in one or more directions from where the subject is located. The map context [symbol] (e.g., one or more pixels of the map context [symbol] ) can include one or more binary channels indicating the presence or absence of a type of feature, such as a semantic property. The channels can include, for example and without limitation, channels such as whether a pixel is a walkable area, an obstacle, a lane, a road segment, a drivable area, a road divider, a lane divider, a crosswalk, a sidewalk, or various combinations thereof.

The remote subjects can be at least a subset of all remote subjects maintained by the system 100; for example, the remote subjects can be any remote subject within a threshold distance from the subject, or within a same grid portion of the environment as the subject.

The system 100 can operate on training data elements 112 (e.g., training data instances), which may be retrieved from one or more databases 108. The one or more databases 112 can be maintained by one or more entities, which may be entities that maintain the system 100 or may be separate from entities that maintain the system 100. In some implementations, the system 100 uses training data from different data sets, such as by using training data elements 112 from a first database 108 to perform at least a first configuration of the models 104, and uses training data elements from a second database 108 to perform at least a second configuration of the models 104. For example, the first database 108 can include publicly available data, while the second database 108 can include domain-specific data (which may be limited in access as compared with the data of the first database 108).

The training data elements 112 can include subject data 116 and remote data 120. The subject data 116 and remote data 120 can respectively include data such as subject state, action, and/or trajectory data (e.g., τ_{S}, τₐ, x^{ego}) and remote subject data (e.g., X^{neigh} and/or state or action data thereof). For example, the subject data 116 (and remote data 120) can include trajectory data including at least positions and/or motion data (e.g., velocity and/or acceleration) of subjects at points in time. The subject data 116 (and remote data 120) can be determined or generated, for example and without limitation, from text, speech, image, or video data of subjects; from synthetic trajectory determination by various simulations or models; from outputs of prior implementations of the machine learning models 104; or various combinations thereof. In some implementations, a plurality of remote trajectories of remote data 120 may be associated with each respective subject trajectory of subject data 116. In some implementations, the subject data 116 includes remote data 120, such that the system 120 can receive, for a given subject data 116, subject data 116 of other subjects to use as remote data 120. For example, for a given training data element 112, the remote data 120 may include identifiers of one or more remote subjects relative to the subject data 116 of the training data element 112. The subject data 116 and remote data 120 can include various identifiers or class information regarding the subjects (and remote subjects), such as identifiers of each subject, classes (of entities or objects that the subjects represent), or groups that the subjects may be assigned to.

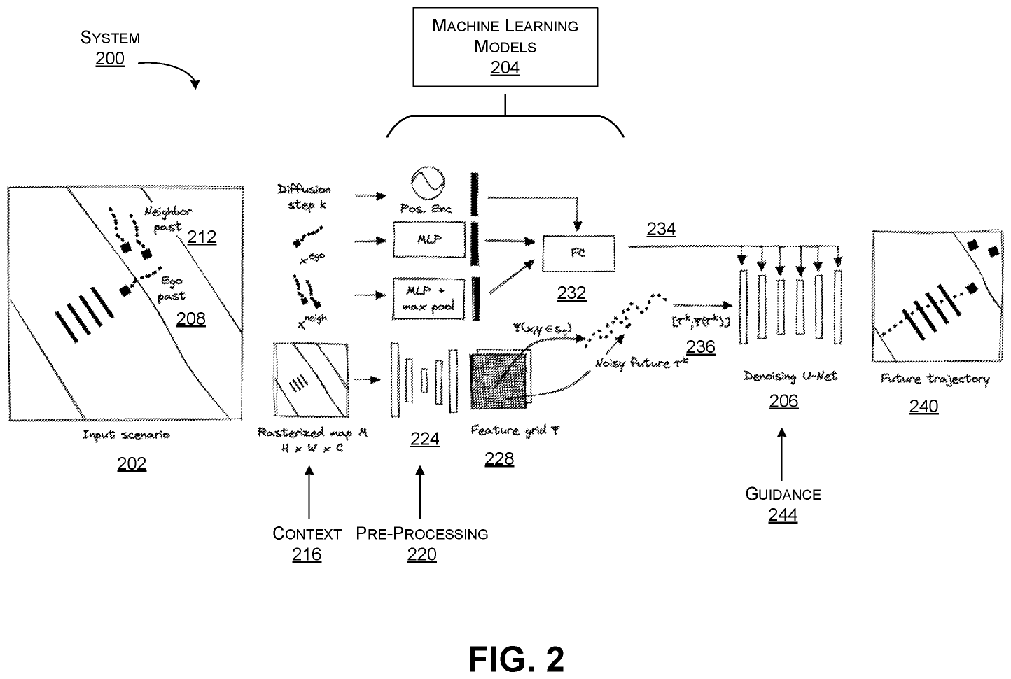

The training data elements 112 can include context data 124. The context data 124 can include data indicative of features described above with reference to the map context [symbol] ; in one or more embodiments the features may be indicative of semantic properties, such as for indicating properties or features including but not limited to walkable areas, obstacles, lanes, road segments, drivable areas, road dividers, lane dividers, crosswalks, sidewalks or various combinations thereof. In some implementations, the context data 124 can include data similar to or indicative of guidance objectives described with reference to guidance 240 of FIG. 2.

As depicted in FIG. 1, the system 100 can perform diffusion on one or more subject trajectories τ⁰, which the system 100 can retrieve from respective subject data 116 (FIG. 1 depicts the trajectory τ⁰ as a solid line as compared with dashed lines of noise trajectories τ¹ . . . τ^{K} described further below; the trajectories τ⁰ may be represented in the subject data 116 as discrete trajectory data elements, such as position and/or motion data (e.g., velocity and/or acceleration) data elements, over time). The trajectories τ⁰ can be clean (e.g., as opposed to trajectories determined using noise) future trajectories of subjects. The system 100 can perform diffusion by applying noise to (e.g., diffusing; augmenting with noise; adding noise) the trajectories τ⁰, to determine noisy training data points (e.g., diffused or noisy data, such as noisy traj ectories).

For example, the system 100 can add the noise to the trajectories τ⁰ (e.g., add a numerical value representing the noise in a same data format as the trajectories τ⁰, to the trajectories τ⁰) to determine the noisy training data points. The system 100 can determine the noise to add to the trajectories τ⁰ using one or more noise distributions, which may indicate a noise level according to a step k (e.g., diffusion step of a sequence or plurality of diffusion steps), where 0<k<K, such that applying noise corresponding to the amount of steps K may result in the training data point τ^{k} representing Gaussian noise. For example, the noise can be a sample of a distribution, such as a Gaussian distribution. The noise associated with a step k can correspond with a duration of time t (e.g., of an interval 0<t<T). The system 100 can apply the noise according to or with respect to the step k and/or a number of steps k (e.g., where 0<k<K as noted above). The value of step k may be a multiple of a number of discrete steps between zero and K. The maximum K may correspond to number of diffusion steps such that the result of applying noise for a duration of time K may be indistinguishable or almost indistinguishable from Gaussian noise.

For example, the system 100 can perform a forward noising process to determine at least one noisy training data point from the clean trajectory τ⁰, such as to determine a plurality of progressively noisier trajectories (τ¹, τ², . . . τ^{k}, . . . τ^{K}). The system 100 can perform the forward noising process by adding noise, such as Gaussian noise, to the trajectories at each process step k:

$$\\ q ( {τ}^{{}^{} 1 : K} \vert {τ}^{{}^{} 0} ) := {\prod }_{k = 1}^{K} q ( {τ}^{{}^{} k} \vert {τ}^{{}^{} k - 1} )$$

$$\\ q ( {τ}^{{}^{} k} \vert {τ}^{{}^{} k - 1} ) := 𝒩 ( {τ}^{{}^{} k} ; \sqrt{1 - {β}_{k}} {τ}^{{}^{} k - 1} , {β}_{k} I$$

where βₖ is a variance that the system 100 can retrieve from a predetermined variance schedule (e.g., for the kth step), the predetermined variance schedule being defined such that for large K, q(τ^{k})˜ [symbol] (τ^{k}; 0, I). As depicted in FIG. 1, the system 100 can apply noise (e.g., a first amount of noise according to the predetermined variance schedule) to the subject trajectory τ⁰ to determine a first noisy trajectory τ¹; apply noise (e.g., a second amount of noise according to the predetermined variance schedule) to the noisy trajectory τ¹ to determine a second noisy trajectory τ², and so forth up to a Kth noisy trajectory τ^{K}.

Referring further to FIG. 1, the machine learning models 104 can be or include at least one denoising network 106 (e.g., neural network) to perform denoising of the noisy training data point τ^{K} to determine an estimated output 128 (e.g., \hat{τ}⁰). The denoising network can be implemented using a U-Net, such as a convolutional neural network that includes downsampling and upsampling paths.

The estimated output 128 can have a same format as the subject trajectories of the subject data 116 and/or of the noisy trajectories τ¹ . . . τ^{K}. For example, the estimated output 128 can include at least motion data (e.g., velocity and/or acceleration, such as \dot{v}, \dot{θ}) for each of plurality of points of time.

For example, the denoising network 106 can have parameters ϕ, and the system 100 can configure the denoising network 106 by performing a denoising process defined as:

p_{ϕ}(τ^{k-1}|τ^{k}, C): = [symbol] (τ^{k-1}; μ_{ϕ}(τ^{k}, k, C), Σₖ)

where the system 100 retrieves Σₖ from a predetermined schedule for denoising, and μ_{ϕ} can represent a mean of a distribution (e.g., Gaussian distribution) of trajectories for a respective denoising step k. For example, at various steps k that reflect the fact that τ^{k} is a noisy representation of the trajectory of the subject, this noisy representation can correspond to a mean value μ_{ϕ} and a standard deviation (which may correspond to the schedule Σₖ). In various implementations, the system 100 can perform various parameterizations to relate variables of the denoising network 106, such as to cause (1) the denoising process to output the clean final trajectory τ⁰, such that μ_{ϕ} can be determined from τ⁰ and τ^{k}; (2) the denoising process to directly output μ_{ϕ}; or (3) the denoising process to output noise ϵ that results in τ^{k} from τ⁰.

In some implementations, the denoising network 106 performs denoising of the training data point τ^{K} according to at least one of (i) one or more remote trajectories of remote data 120 corresponding to the subject data 116 having the subject trajectory τ⁰ or (ii) one or more context data C of context data 124. For example, the system 100 can provide, as input to the denoising network 106, the remote trajectories (e.g., X^{neigh} corresponding to τ⁰). The system 100 can provide, as input to the denoising network 106, the map context [symbol] vr corresponding to τ⁰.

The system 100 can configure (e.g., train, modify, update, etc.) the denoising network 106 based at least on the subject trajectories τ⁰ of the subject data 116 and the estimated outputs 128 (e.g., \hat{τ}⁰) determined from respective subject trajectories τ⁰. For example, the system 100 can use various objective functions, such as cost functions or scoring functions, to evaluate the estimated (e.g., candidate) outputs 128 according to a comparison of the estimated outputs 128 with the subject trajectories τ⁰ of the subject data 116. The system 100 can update the denoising network 106 responsive to output of the objective function, such as to modify the denoising network 106 responsive to whether the comparison between the estimated outputs 128 and the corresponding subject trajectories τ⁰ of the subject data 116 satisfies various convergence criteria (e.g., an output of the objective function is less than a threshold output or does not change more than a predetermined value over a number of iterations; a threshold number of iterations of training is completed). The objective function can include, for example and without limitation, a least squares function, an L1 norm, or an L2 norm. The objective function can receive, as input, at least (1) the estimated output 128 (2) the ground truth data (e.g., subject trajectory τ⁰ of the subject data 116 from which the denoising network 106 determined the estimated output 128), and can determine an objective value as output responsive to the input.

In some implementations, to evaluate processing by the denoising network 106, the system 100 uses the objective function:

L= [symbol] _{∈,k,τ}⁰,C[∥τ⁰−\hat{τ}⁰∥²]

where τ⁰ is the ground truth subject trajectory of the subject data 116, C includes at least one of the remote trajectories or the context data 124 corresponding to the subject data 116, k˜U {1, 2, . . . K} represents an index of the steps k of the denoising process, and ∈˜ [symbol] (0, I) represents the noise applied to the subject trajectory τ⁰ to determine For example, to determine τ¹ . . . τ^{K}. For example, to determine \hat{τ}⁰ for configuring the denoising network 106, the system 100 can (randomly) select a diffusion step k and noise level ϵ for diffusing the subject trajectory τ⁰ into τ^{k}, and evaluate the denoising network 106 using the objective function given \hat{τ}⁰, τ⁰, and the selected k and ϵ.

In some implementations, the system 100 configures the machine learning models 104, including the denoising network 106, to allow for classifier-free operation of the machine learning models 104 at test time. For example, the system 100 can train, update, or otherwise configure a first denoising network 106 using conditioning (e.g., by using remote subject data 120 and/or context data 124) and configure a second denoising network 106 without conditioning (e.g., by not using at least one of remote subject data 120 or context data 124). For example, the system 100 can determine the first denoising network 106 as a conditional model μ_{ϕ}(τ^{k}, k, C) and can determine the second denoising network 106 as an unconditional model μ_{ϕ}(τ^{k}, k). As described further with reference to FIG. 2, outputs of the condition and unconditional models can be weighted in various manners, providing a user greater controllability while enabling the networks 106 to be trained using datasets with varying annotations (e.g., since the models are trained with conditioning being randomly dropped out, mixed data with subsets of the full conditioning can be used; since datasets may include pedestrian datasets with diverse motions but no semantic maps, and may include datasets with limited motions and detailed maps, mixed training can facilitate trajectory diversity and controllability under various such input conditions).

The system 100 can apply various machine learning model optimization or modification operations to modify the machine learning model 104 responsive to the outputs of the objective function. For example, the system 100 can use a gradient descent operation, such as stochastic gradient descent.

In some implementations, the system 100 uses at least some different subsets of the data 124 to configure the machine learning models 104. For example, the system 100 can use a first subset, such as a first batch, of the training data elements 112 to perform a first configuration of the denoising network 106, and a second subset, such as a second batch, of the training data elements 112 to perform a second configuration of the denoising network 106. The first subset and second subset may be from the same or different databases 108, such as different databases 108 having different levels of public accessibility. The first subset may be a training dataset, and the second subset may be a test or validation subset. The databases 108 can include data of different types of annotations, such as annotations indicating different classes or categories of objects or features.

FIG. 2 depicts an example computing environment including a system 200, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 200 can include any function, model (e.g., machine learning model), operation, routine, logic, or instructions to perform functions such as configuring, deploying, updating, and/or generating outputs from machine learning models 204, as described herein. The system 200 can incorporate features of the system 100, including to perform training operations for configuring and updating machine learning models 104. For example, the machine learning models 104 can include and be trained or otherwise configured with a model architecture that includes the pre-processing 220 components such as featurizer 224, as well as fully-connected layer 232; the machine learning models 104 can be configured by concatenating noisy trajectories τ^{k} with featurized context data determined from context data C and/or map context [symbol] . The system 200 can be implemented at least partially by the same or different entities or devices that implement the system 100.

The system 200 can include at least one machine learning model 204. The machine learning model 204 can include the machine learning model 104 and/or the denoising network 106 of FIG. 1 or a representation or variation thereof. The machine learning models 204 or portions thereof can be received from the system 100 of FIG. 1 as a data structure that includes the machine learning model 104 or a representation or variation thereof, such as a data structure representing the structure of the machine learning model 104 (e.g., layers or arrangements of layers) or the parameters of the machine learning model 104. In some implementations, the system 200 can operate machine learning models 204 to control determination of trajectories of pedestrians or other subjects or agents according to one or more guidance criteria, which can facilitate determination of realistic trajectory determination.

The system 200 can receive at least one input 202, which can represent one or more states or scenarios of an environment. The input 202 can include at least one past trajectory 208 of a subject. The past trajectory 208 can be similar to the subject data 116 described with reference to FIG. 1. For example, the past trajectory 208 can include at least one of state data (e.g., position and/or motion data) or action data (e.g., motion data, such as velocity and/or acceleration data) regarding one or more past states of the subject, such as states through which the subject has moved up to a current time point. The input 202 can include at least one neighbor past trajectories 212 of one or more remote subjects, such as other pedestrians or other remote entities in the environment. The neighbor past trajectories 212 can be similar to the remote data 120 described with reference to FIG. 1. For example, the neighbor past trajectories 212 can include at least one of state data (e.g., position and/or motion data) or action data (e.g., motion data, such as velocity and/or acceleration data) regarding one or more past states of the remote subjects, such as states through which the remote subjects have moved up to a current time point.

The input 202 can include context data 216, which can be similar to context data 124 described with reference to FIG. 1. For example, the context data 216 can include 3D information representative of objects or other features in the environment. The context data 216 can indicate semantic classes or categories of the features in the environment. In some implementations, the system 200 represents the context data 216 in a map data structure, depicted as rasterized map [symbol] . For example, the map data structure can be a top down or bird's eye view data structure, in which two dimensions (H, W) represent lateral directions (e.g., front/back and left/right), and a third dimension represents features at corresponding coordinates (e.g., pixels) of the map data structure. The map data structure can include additional dimensions to encode information such as height, class, etc. of features.

The machine learning models 204 can include one or more pre-processing components 220 to modify the inputs 202 or portions thereof for further processing. For example, the pre-processing components 220 can perform various filtering, featurizing, compression, or other operations to prepare or modify the inputs 202 for downstream processing. As depicted in FIG. 2, the machine learning models 204 can include a featurizer 224. The featurizer 224 can include a neural network, such as a convolutional neural network (CNN), such as a 2D convolutional neural network, configured to determine a feature grid Ψ from the map data structure. The feature grid Ψ can include a plurality of pixels, in which one or more pixels indicates a high-dimensional feature, such as a single feature representative of features of the map data structure at each pixel.

In some implementations, the pre-processing components 220 can include at least one of a position encoder, one or more multi-layer perceptrons (MLPs), or a fully-connected (FC) layer 232. For example, as depicted in FIG. 2, the position encoder can apply sin/cosine position encoding to the denoising step k, and the MLPs can process the respective past subject trajectory 208 (x^{ego}) and remote subject trajectories 212 (X^{neigh}) to provide these features to the FC layer 232 to determine a conditioning feature 234 (e.g., single conditioning feature). As such, the pre-processing components 220 can determine the conditioning feature 234 from at least one of the diffusion step k, the state of the subject, the past trajectory of the subject, or the past trajector(ies) of remote subjects, and apply the conditioning feature 234 to one or more layers of denoising network 206. Various such pre-processing components 220 can operate with respect to various iterations of processing the noisy trajectories τ^{k} (which can represent estimated or candidate trajectories for the subject) for example, pre-processing may be performed once, and data determined from pre-processing can subsequently be retrieved for any denoising step k as needed.

Referring further to FIG. 2, the system 200 can combine information from the feature grid Ψ with the noisy subject trajectory τ^{k} (e.g., where the denoising schedule Σₖ described with reference to FIG. 1 can be used to denoise a (fully) noisy trajectory sample τ^{K} through steps K−1, K−2, . . . k+1, k, k−1, etc.). For example, the system 200 can identify each of a plurality of positions represented by τ^{k} (e.g., the positions of the states of the subject that make up the trajectory τ^{k} for each respective time step of the trajectory τ^{k}), and for each position of the plurality of positions, retrieve a feature from a corresponding position of the feature grid Ψ to determine a feature trajectory Ψ(96 ^{k}). The system 200 can retrieve the feature from the corresponding feature of the feature grid Ψ by interpolating between the positions of the noisy trajectories and the positions of the pixels of the feature grid Ψ. The system 200 can combine the noisy subject trajectory τ^{k} and the feature trajectory Ψ(96 ^{k}) by concatenating the noisy subject trajectory τ^{k} with the feature trajectory Ψ(96 ^{k}). The system 200 can combine the noisy subject trajectory τ^{k} and the feature trajectory Ψ(96 ^{k}) to determine an input 236, which can allow the system 200 to determine a localized representation of the environment around the subject, which can facilitate map interactions such as obstacle avoidance.

Referring further to FIG. 2, the machine learning models 204 can include at least one denoising network 206. The denoising network 226 can incorporate aspects of the denoising network 106 described with reference to FIG. 1. For example, the denoising network 226 can be a trained instance of the denoising network 106, can have weights/parameters defined from the trained denoising network 106, etc.

The denoising network 226 can receive, as input, the input 236 (e.g., receive data representative of at least one of the noisy trajectory τ^{k} or the feature trajectory Ψ(τ^{k})), and can determine a trajectory 240 responsive to the input. The trajectory 240 can be a future trajectory, such as a trajectory indicating states of the subject subsequent to the states of the past trajectory x^{ego}. For example, the trajectory 240 can include a plurality of future states of the subject, such as states continuing from x^{ego}. The trajectory 240 can include a prediction of a clean (e.g., not noisy) final trajectory \hat{τ}⁰ of the subject. The trajectory 240 can include a state of the subject at a second time point that may be subsequent to a first time point of ego (e.g., subsequent to a latest time point of x^{ego}).

As depicted in FIG. 2, the denoising network 226 can receive, as input, the conditioning feature 234. For example, the conditioning feature 234 can be combined with (e.g., added to) the intermediate trajectory received by and/or determined by any one or more of the layers of the denoising network 206, such as to add the conditioning feature 234 to the inputs to each of the layers of the denoising network 206. This can enable the denoising network 226 to account for the subject's prior states, as well as states of neighboring subjects, along with the overall process of denoising, to inform how to determine the future trajectory 240.

Referring further to FIG. 2, the system 200 can determine the trajectory 240 according to guidance 244, which can indicate criteria for determination of the trajectory 240, such as to allow for controllability of the trajectory 240. The guidance 244 can represent a loss according to an amount by which the trajectory 240 violates or deviates from a guidance objective, such as a user-defined or user-inputted objective. The guidance 244 can include one or more instructions, rules, heuristics, models, policies, functions, algorithms, etc., which the system 200 can use to control, modify, update, or perturb how the denoising network 226 determines the trajectory 240. The system 200 can select or determine the guidance according to user input, such as quantitative, qualitative, and/or semantic input indicating the objective(s) that a user is directing the system 200 to follow for determining the trajectories 240. The system 200 can apply the guidance 244 to various portions of the processing pipeline for determining the trajectory 240, including but not limited to the trajectory 240 (e.g., the clean final trajectory \hat{τ}⁰), such as to back-propagate a result (of applying the guidance 244 to the trajectory 240) to the denoising network 206. The guidance 244 can indicate penalties and/or rewards associated with distances of the subject with respect to other subjects or objects or features in the environment meeting criteria such as minimum or maximum thresholds.

The guidance 244 can be defined as a function [symbol] , which can be a learned function or a differentiable analytical function. For example, the function [symbol] can be learned including guidance information in context data 124 as part of training the denoising network 106, or using one or more separate neural networks that are trained or configured using training data that includes examples of trajectories and guidance information, such as to learn reward and/or loss values associated with how trajectories are arranged relative to target states corresponding with guidance information. In some implementations, the system 200 uses the guidance 244 by defining the denoising process as:

p_{ϕ}(τ^{k-1}|τ^{k}, C): = [symbol] (τ^{k-1}; \tilde{μ}_{ϕ}(τ^{k}, k, C), Σₖ)

where \tilde{μ} represents the mean subsequent to perturbation. As noted above, various variables of the denoising process can have the guidance 244 applied; for example, the guidance 244 can be applied to the clean final trajectory \hat{τ}⁰, which can mitigate or avoid numerical issues associated with analytical loss functions and/or mitigate or avoid the need to train across varying noise levels. For example, at each denoising step k, the predicted clean final trajectory \hat{τ}⁰ can be modified using the guidance 244 to determine a modified trajectory \tilde{τ}⁰:

\tilde{τ}⁰=\hat{τ}⁰−αΣₖ∇_{τ}_{ₖ} [symbol] (\hat{τ}⁰)

The system 200 can use the modified trajectory \tilde{τ}⁰ to determine the modified mean \tilde{μ} from

p_{ϕ}(τ^{k-1}|τ^{k}, C): = [symbol] (τ^{k-1}; \tilde{μ}_{ϕ}(τ^{k}, k, C), Σₖ).

The guidance 244 (e.g., guidance function [symbol] ) can indicate at least one of a waypoint, obstacle avoidance, collision avoidance, or social group movement. For example, the guidance 244 can indicate at least one of subject avoidance (e.g., avoiding collisions or distances between subjects being less than a threshold) or social distance criteria, such as to indicate a penalty value for distances between subjects being less than a threshold (e.g., a nonzero threshold or a threshold of zero to indicate collision). The guidance 244 can indicate obstacle avoidance, such as by indicating a penalty value for the subject (or a point of a bounding box of the subject) entering a threshold distance of the obstacle. The guidance 244 can indicate waypoints for the trajectory to pass through at specific time steps or any time step, such as by assigning rewards for the trajectory passing through the way point and/or penalties for not passing through the waypoint. The guidance 244 can indicate rewards for the subject remaining within a distance of one or more other subjects of a social group (or penalty values for not remaining within the distance).

In some implementations, the system 200 can determine the trajectory 240 based at least on (i) a conditional network and (ii) an unconditional network. For example, as described with reference to FIG. 1, the denoising networks 106 can be determined as conditional model μ_{ϕ}(τ^{k}, k, C) and unconditional model μ_{ϕ}(τ^{k}, k); the machine learning models 204 can include one or more networks 206, which can include a conditional network corresponding to the conditional model μ_{ϕ}(τ^{k}, k, C) and an unconditional network corresponding to the unconditional model μ_{ϕ}(τ^{k}, k). The system 200 can determine the trajectory 240 using the networks 206, such as by performing a weighting of parameters associated with the outputs of the networks 206:

\tilde{∈}_{ϕ}=∈_{ϕ}(τ^{k}, k, C)+w(∈_{ϕ}(τ^{k}, k, C)−∈_{ϕ}(τ^{k}, k))

where ∈_{ϕ} represents a prediction of the machine learning models 204 of an amount of noise added to the trajectory 240 to determine τ^{k}. For example, weighting with w>0 can increase the effect of conditioning; weight with w<0 can decrease the effect of conditioning; setting w to 1 can result in the use of a purely conditional network 206; setting w to −1 can result in the use of a purely unconditional network 206; various such settings can be determined responsive to user input to facilitate controllability.

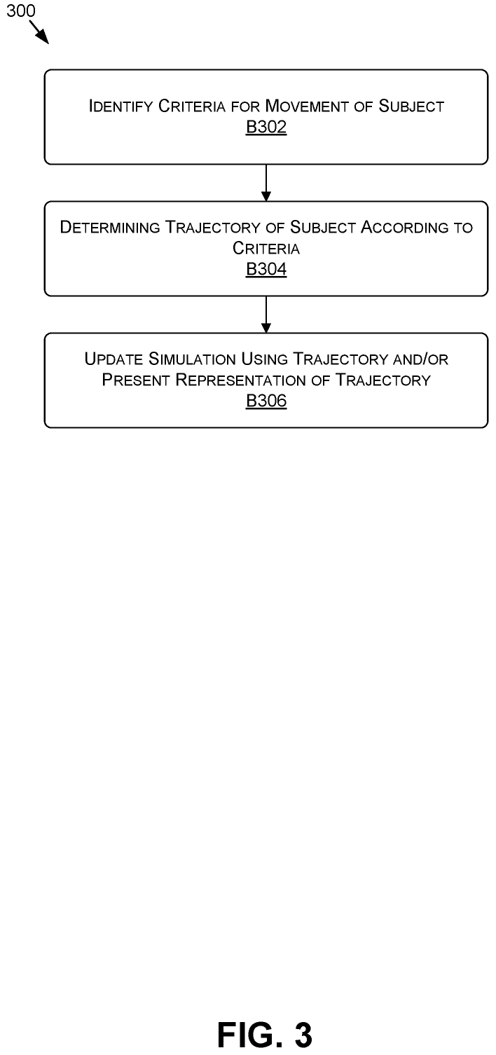

Now referring to FIG. 3, each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the systems of FIG. 1 and FIG. 2. However, this method 300 may additionally or alternatively be executed by any one system, or any combination of systems, including, but not limited to, those described herein.

FIG. 3 is a flow diagram showing a method 300 for determining states of subjects moving in an environment, such as to determine trajectories of subjects using neural networks, in accordance with some embodiments of the present disclosure. Various operations of the method 300 can be implemented by the same or different devices or entities at various points in time. For example, one or more first devices may implement operations relating to configuring (e.g., updating or training) diffusion models, and one or more second devices may implement operations relating to determining trajectories using diffusion models. The one or more second devices may maintain the neural network models, or may access the neural network models using, for example and without limitation, APIs provided by the one or more first devices.

The method 300, at block B302, includes identifying one or more criteria for movement of a subject in an environment. The environment can include at least one of a simulated environment (e.g., virtual environment) or a simulated representation of a real world environment. In some embodiments, the environment can by a physical or real world environment. The subject can include various entities that may be present or moving in the environment, including but not limited to pedestrians or vehicles. The criteria can include criteria for subjects, objects, or features of the environment for the subject to maintain distances relative to, such as according to minimum and/or maximum thresholds. For example, the criteria can include, without limitation, criteria associated with guidance criteria such as waypoints, collision avoidance, obstacle avoidance, social distance, and movement in social groups. For example, the criteria can indicate a distance to maintain with respect to one or more remote subjects.

The criteria can be received as user input, such as by presenting a prompt via a user interface to request the user input. The criteria can be retrieved from at least one of a learned function or an analytical function.

The method 300, at block B304, includes determining, using a neural network, a trajectory of the subject according to the one or more criteria. For example, the neural network can include a denoising network configured to determine, from a noisy representation of a candidate trajectory, the trajectory of the subject. The denoising network can determine the trajectory using information such as state data of the subject (e.g., past trajectory of the subject), state data of remote subjects (e.g., trajectory data of other subjects in the environment), and context data of the environment, such as locations of road, obstacles, or other areas to move through or avoid. For example, a path of the trajectory can be used to query a map representation of the environment to identify locations of features of the environment that coincide with the path, to determine the trajectory according to the identified features.

The neural network can be configured (e.g., trained) using training data representing subject trajectories. For example, the training data can include examples of subject trajectories, trajectories of remote subjects, and context information regarding the environment, such as information indicating obstacles, lanes, lane dividers, or other features that pedestrians or vehicles may account for while moving in the environment.

The method 300, at block B306, includes at least one of (i) updating a representation of the trajectory of the subject in the environment or (ii) present, using a display, the trajectory of the subject in the environment. For example, a simulation or other computer representation of the environment can be updated in time, during which the subject can be moved through the trajectory. The simulation or other representation can be displayed using a display device. In some implementations, the trajectory is used for vehicle control, such as for testing operation of an autonomous vehicle controller.

### Example Content Streaming System

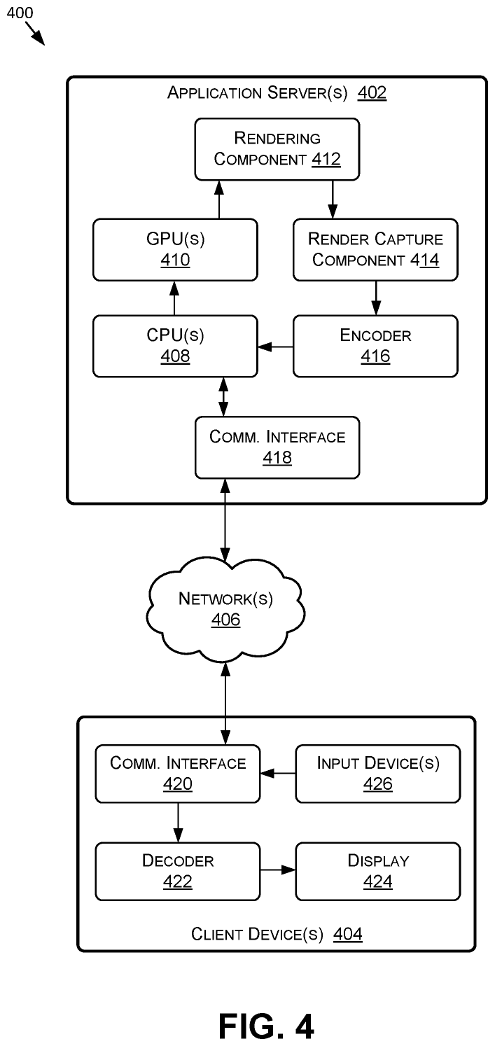

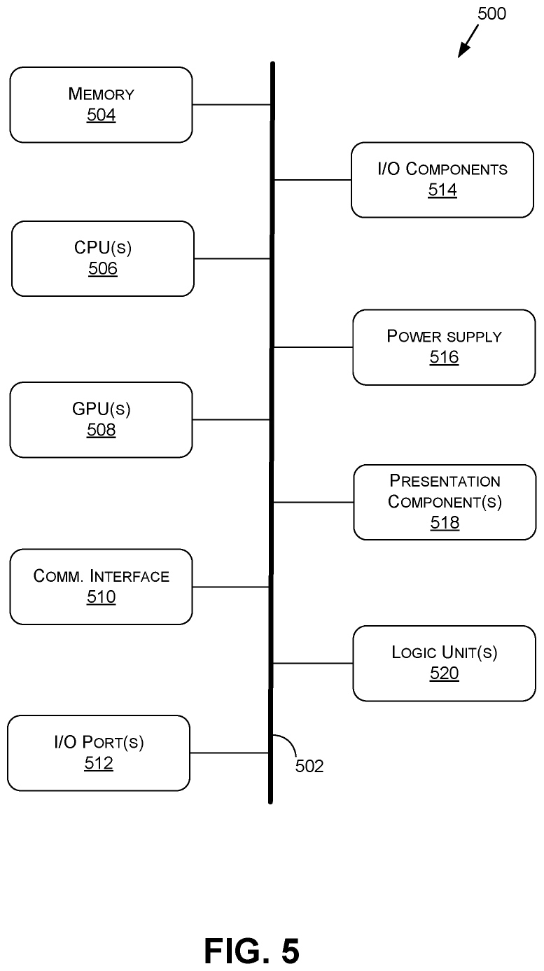

Now referring to FIG. 4, FIG. 4 is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 400 may be implemented to perform diffusion model training and runtime operations. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 400 can be implemented to receive input indicating one or more features of output to be generated using a neural network model, provide the input to the model to cause the model to generate the output, and use the output for various operations including display or simulation operations.

In the system 400, for an application session, the client device(s) 404 may only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based on receiving the display data from the application server(s) 402. The client device 404 may receive an input to one of the input device(s) and generate input data in response, such as to provide modification inputs of a driving signal for use by modifier 112. The client device 404 may transmit the input data to the application server(s) 402 via the communication interface 420 and over the network(s) 406 (e.g., the Internet), and the application server(s) 402 may receive the input data via the communication interface 418. The CPU(s) 408 may receive the input data, process the input data, and transmit data to the GPU(s) 410 that causes the GPU(s) 410 to generate a rendering of the application session. For example, the input data may be representative of a movement of a character of the user in a game session of a game application, firing a weapon, reloading, passing a ball, turning a vehicle, etc. The rendering component 412 may render the application session (e.g., representative of the result of the input data) and the render capture component 414 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc.—may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may be arranged in various topologies, including but not limited to bus, star, ring, mesh, tree, or hybrid topologies. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508. In some embodiments, a plurality of computing devices 500 or components thereof, which may be similar or different to one another in various respects, can be communicatively coupled to transmit and receive data for performing various operations described herein, such as to facilitate latency reduction.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user, such as to generate a driving signal for use by modifier 112, or a reference image (e.g., images 104,). In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

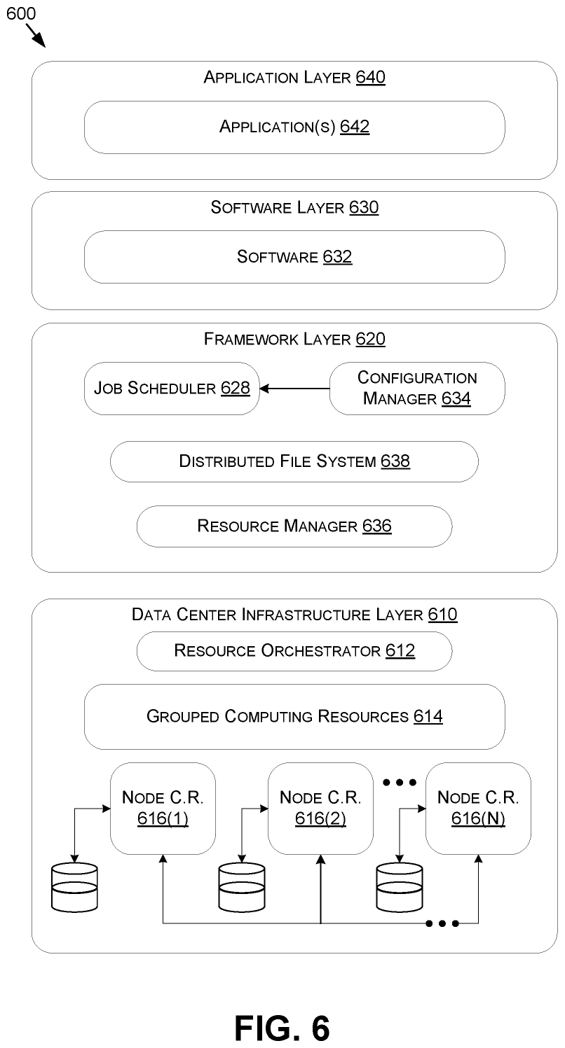

FIG. 6 illustrates an example data center 600 that may be used in at least one embodiments of the present disclosure, such as to implement the systems 100, 200 in one or more examples of the data center 600. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-616(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N) grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to train, configure, update, and/or execute machine learning models 104, 204.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models (e.g., train models 104, 204 and/or neural networks 106, 206, etc.) or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one more circuits to:
identify one or more criteria for movement of a subject in an environment;
determine, using a neural network, a trajectory of the subject according to the one or more criteria, the neural network updated using training data representing subject trajectories; and
at least one of (i) update a representation of the trajectory of the subject in the environment or (ii) present, using a display, the trajectory of the subject in the environment.

2. The processor of claim 1, wherein the subject is a first subject, and the one or more circuits are used to determine, using the neural network, the trajectory further according to a position of the subject, motion of one or more second subjects, and a map representing features of the environment.

3. The processor of claim 1, wherein the subject is a first subject, and the one or more criteria correspond to at least one of collision avoidance or distance to maintain with respect to one or more second subjects.

4. The processor of claim 1, wherein the neural network comprises a diffusion model configured to determine the trajectory by denoising a representation of one or more candidate trajectories based at least on the one or more criteria.

5. The processor of claim 4, wherein the diffusion model is configured to:
perform the denoising between a first time point and a second time point to determine the trajectory at the second time point;
determine the representation of the one or more candidate trajectories at the second time point; and
modify the representation using the one or more criteria at the second time point.

6. The processor of claim 1, wherein the training data comprises a first subset of training data having a first type of annotation and a second set of training data having a second type of annotation.

7. The processor of claim 1, wherein the trajectory comprises a plurality of locations, and the one or more circuits are used to determine, using the neural network, the trajectory further by identifying one or more features of the environment at the plurality of locations.

8. The processor of claim 1, wherein the one or more circuits are used to operate a controller of an autonomous vehicle in the environment, according to the trajectory of the subject.

9. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model
(LLM);
a system for generating synthetic data;
a system incorporating one or more virtual machines (VMs);
a system implemented at least partially in a data center; or
a system implemented at least partially using cloud computing resources.

10. A processor comprising:
one or more circuits to:
determine, using a neural network and based at least on processing a training data instance including a trajectory of a subject, an estimated trajectory of the subject; and
update one or more parameters of the neural network according to the trajectory and the estimated trajectory.

11. The processor of claim 10, wherein the neural network is configured to apply noise to the trajectory to determine a noisy trajectory and modify the noisy trajectory to determine the estimated trajectory, wherein the one or more circuits are used to update the one or more parameters of the neural network responsive to a comparison of the trajectory and the estimated traj ectory.

12. The processor of claim 10, wherein the one or more circuits are used to configure the neural network using a plurality of training data instances comprising the training data instance, wherein the plurality of training data instances comprises a first subset having a first type of annotation and a second subset having a second type of annotation different from the first type.

13. The processor of claim 12, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for generating synthetic data;
a system incorporating one or more virtual machines (VMs);
a system implemented at least partially in a data center; or
a system implemented at least partially using cloud computing resources.

14. A method, comprising:
identifying, by using one or more processors, one or more criteria for movement of a subject in an environment;
determining, using the one or more processors and a neural network, a trajectory of the subject according to the one or more criteria, the neural network updated using training data representing subject trajectories; and
at least one of (i) updating, using the one or more processors, a representation of the trajectory of the subject in the environment or (ii) presenting, using the one or more processors and using a display, the trajectory of the subject in the environment.

15. The method of claim 14, wherein the subject is a first subject, and the method comprises determining, using the one or more processors and the neural network, the trajectory further according to a position of the subject, motion of one or more second subjects, and a map representing features of the environment.

16. The method of claim 14, wherein the subject is a first subject, and the one or more criteria correspond to at least one of collision avoidance or distance to maintain with respect to one or more second subjects.

17. The method of claim 14, further comprising determining, using the one or more processors and a diffusion model of the neural network, the trajectory by denoising a representation of one or more candidate trajectories based at least on the one or more criteria.

18. The method of claim 17, further comprising:
performing, using the one or more processors, the neural network, the denoising between a first time point and a second time point to determine the trajectory at the second time point;
determining, using the one or more processors, the representation of the one or more candidate trajectories at the second time point; and
modifying, using the one or more processors, the representation using the one or more criteria at the second time point.

19. The method of claim 14, wherein the training data comprises a first subset of training data having a first type of annotation and a second set of training data having a second type of annotation.

20. The method of claim 14, wherein the trajectory comprises a plurality of locations, and the method comprises determining, using the one or more processors, the trajectory further by identifying one or more features of the environment at the plurality of locations.
